(19) United States
(12) Patent Application Publication
(10) Pub. No.: US 2011/0285785 A1
(43) Pub. Date: Nov. 24, 2011

(54) FLUID EJECTING APPARATUS

(75) Inventor: Takato HAYASHI, Minowa-machi (JP)

(73) Assignee: SEIKO EPSON CORPORATION, Tokyo (JP)

(21) Appl. No.: 13/110,152

(22) Filed: May 18, 2011

(30) Foreign Application Priority Data
May 18, 2010 (JP) 2010-114170

(51) Int. Cl. B41J 2/165

(52) U.S. Cl. 347/31

(57) ABSTRACT

A fluid ejecting apparatus includes a line-shaped absorbing member that extends along a nozzle row and absorbs fluid ejected from nozzles, a head moving mechanism that moves a fluid ejecting head between a standby position and a flushing position, and an absorbing member moving mechanism that moves the absorbing member between the flushing position and the standby position. As the fluid ejecting head is moved from the standby position to the flushing position, the absorbing member is moved from the standby position to the flushing position.

### CROSS REFERENCES TO RELATED APPLICATIONS

The present invention contains subject matter related to Japanese Patent Application No. 2010-114170 filed in the Japanese Patent Office on May 18, 2010, the entire contents of which are incorporated herein by reference.

### BACKGROUND

1. Technical Field

The present invention relates to a fluid ejecting apparatus.

2. Related Art

Hitherto, as a fluid ejecting apparatus that ejects ink droplets onto a recording sheet (medium), an ink jet printer (hereinafter, referred to as a “printer”) is widely known. In such a printer, there is a problem in that clogging of nozzles occurs due to thickening or solidification of ink caused as the ink vaporizes from the nozzles of a recording head, adhesion of dust, incorporation of bubbles, and the like, resulting in printing failure. Here, in the printer, separately from ejection of ink onto a recording sheet, a flushing operation of forcibly discharging ink in the nozzles is performed.

In general, in a scan type printer, the flushing operation is performed by moving a recording head to an area other than a recording area. However, in a printer having a line head to which a recording head is fixed, the recording head cannot be moved during the flushing operation.

Therefore, for example, a method of discharging ink toward an absorbing material (absorbing member) provided on the surface of a transport belt that transports a recording sheet is considered (JP-A-2007-62339). In this technique, an opening portion into which a nozzle formation surface of a recording head can be inserted is provided in a portion of the transport belt, and a surface of a flushing belt in which the opening portion is not formed and which is opposed to the nozzle formation surface is formed as an ink accommodation portion during flushing.

In the case of this technique, a recording operation is performed on the recording sheet on the transport belt opposed to the nozzle formation surface in a state where the nozzle formation surface of the recording head is inserted into the opening provided in the flushing belt, and the flushing operation is performed on a portion of the flushing belt in which the opening portion is not formed by turning the flushing belt after raising the recording head to take out the nozzle formation surface from the opening.

However, when flushing is performed on a plane-shaped absorbing material, there is a concern that mist-like ink scatters due to wind pressure caused by the discharge of ink droplets and thus the recording sheet or the transport belt is made dirty.

Here, it is considered that a line-shaped material is used as the absorbing material, the line-shaped absorbing member (absorbing material) is disposed between the line head and the recording sheet (recording medium), and ink is ejected thereto to perform flushing, such that the ink is accommodated in the absorbing member. In this case, an amount of ink that can be accommodated in the absorbing member is limited. Therefore, it is considered that when a certain amount of ink is accommodated, the absorbing member is moved such that flushing is performed on a new area of the absorbing member and ink is accommodated again.

Until now, it is typical that the recording head is not moved during the flushing operation. However, as an interval between the nozzle formation surface and the recording sheet is very narrow, the recording head may be raised as in the technique disclosed in JP-A-2007-62339 described above. However, in this technique, as the flushing belt has to be moved after raising the recording head, it takes time to perform the flushing operation.

### SUMMARY

An advantage of some aspects of the invention is to provide a fluid ejecting apparatus capable of preventing contamination of a recording medium (recording sheet) using a line-shaped absorbing member that accommodates fluid, and rapidly moving a head and the absorbing member when flushing is performed by the absorbing member, thereby reducing the time taken to perform the flushing.

According to an aspect of the invention, there is provided a fluid ejecting apparatus including: a nozzle row including a plurality of nozzles arranged in a direction intersecting a transport direction of a recording medium; a fluid ejecting head that ejects fluid from the nozzle row; an absorbing member that extends along the nozzle row and absorbs fluid ejected from the nozzles; a head moving mechanism that moves the fluid ejecting head between a standby position and a flushing position; and an absorbing member moving mechanism that moves the absorbing member between the flushing position and the standby position. As the fluid ejecting head is moved from the standby position to the flushing position, the absorbing member is moved from the standby position to the flushing position.

In the liquid ejecting apparatus according to the aspect of the invention, as the fluid ejecting head is moved to the flushing position from the standby position by the head moving mechanism that moves the fluid ejecting head and the absorbing member moving mechanism that moves the absorbing member, the absorbing member is moved from the standby position to the flushing position. According to the related art, a sheet-like flushing reception cannot be moved after a head is raised. However, according to this aspect of the invention, it becomes possible to simultaneously move the fluid ejecting head and the absorbing member using the line-shaped absorbing member, thereby reducing a time taken to perform the flushing. Accordingly, maintenance efficiency is enhanced.

In addition, a wider clearance can be opened between the fluid ejecting head and the transport surface during the flushing operation than that during recording, and the absorbing member is disposed at the clearance, such that it becomes possible to avoid the absorbing member from coming into contact with other members, thereby preventing fluid from adhering to and contaminating the other members.

In addition, it is preferable that the absorbing member moving mechanism and the head moving mechanism be configured to have the same driving motor.

According to this aspect of the invention, a single driving motor causes both the absorbing member moving mechanism and the head moving mechanism to operate, thereby promoting a reduction in the size of the apparatus.

In addition, it is preferable that the absorbing member moving mechanism move the absorbing member obliquely with respect to the transport direction so that an interval between the absorbing member and the transport surface of the recording medium at the retraction position is greater than that at the flushing position.

According to this aspect of the invention, when the fluid ejecting head performs the recording operation on the recording medium, contact between the absorbing member at the retraction position and the recording medium is avoided, thereby preventing the recording medium from being contaminated.

In addition, it is preferable that the head moving mechanism include: a holding member that holds the fluid ejecting head; a turning support member that supports one end side of the holding member to be turnable; and a cam portion that oscillates the holding member by supporting and rotating the other end side of the holding member to cause the fluid ejecting head to reciprocate between the standby position and the flushing position.

According to this aspect of the invention, since the one end side of the holding member is supported by the turning support member and the other end side thereof is supported by the cam portion, the other end side of the holding member is oscillated about the one end side supported by the turning support member as a fulcrum as the cam portion is rotated, and it becomes possible to reciprocate the fluid ejecting head between the standby position and the flushing position. As such, a rotation amount of the cam portion can be directly transmitted to the fluid ejecting head via the holding member, thereby reducing the size of the apparatus.

In addition, it is preferable that a side peripheral surface of the cam portion be provided with a first area to dispose the fluid ejecting head at the flushing position and a second area to dispose the fluid ejecting head at the standby position.

According to this aspect of the invention, during a period in which the holding member comes into contact with the first area of the contact surface, the fluid ejecting head is maintained at the flushing position, and during a period in which the holding member comes into contact with the second area of the contact surface, the fluid ejecting head is maintained at the standby position, so that the position of the fluid ejecting head can be changed by the rotation amount of the cam portion.

In addition, it is preferable that a cap member that is disposed at a position opposed to a nozzle formation surface of the fluid ejecting head via the transport surface to seal the nozzle formation surface be further included, and the side peripheral surface of the cam portion be provided with a third area to dispose the fluid ejecting head at a position to cause the nozzle formation surface to be sealed by the cap member.

According to this aspect of the invention, during a period in which the holding member abuts on the third area of the cam portion, the nozzle formation surface of the fluid ejecting head can be sealed by the cap member.

In addition, it is preferable that the head moving mechanism be provided with a pressing member that presses the holding member against the cam portion side.

According to this aspect of the invention, it becomes possible to maintain a state of the holding member coming into contact with the cam portion. Particularly, in a period in which the nozzle formation surface is sealed by the cap member, the sealed state can be reliably maintained by the cap member, so that sealing by the cap member can be properly performed.

In addition, it is preferable that a cover member that is disposed between the transport surface and the cap member to cover the cap member be included.

According to this aspect of the invention, since the cap member is covered by the cover member during the recording operation or the flushing operation, the recording medium during transportation is prevented from coming into contact with the cap member. Accordingly, proper transportation of the recording medium can be performed without affecting the transportation. In addition, since the cap member is covered, the cap member is prevented from being contaminated by fluid that does not land in the recording medium and passes therethrough. For example, when the cap member is sealed so that the nozzle formation surface abuts on the cover member, there is no concern of the nozzle formation surface being contaminated.

In addition, it is preferable that a pair of the cam portions be disposed on both sides in the direction intersecting the transport direction of the fluid ejecting head, and the pair of the cam portions be connected to the same driving motor.

According to this aspect of the invention, a large fluid ejecting head can also be applied. For example, even in a fluid ejecting head that has a length in the width direction of the recording medium intersecting the transport direction, strength can be ensured by supporting the fluid ejecting head with the cam portions disposed on both sides in the length direction.

In addition, it is preferable that a rack and pinion mechanism that has the holding member, the turning support member, the cam portion, and a pinion that is engaged with a gear cutting portion formed on the rear surface of the holding member that has the same shaft of the cam portion be included, and the rack and pinion mechanism has functions of both the head moving mechanism and the absorbing member moving mechanism.

According to the invention, the structure of the apparatus is simple and a reduction in cost can be achieved.

### BRIEF DESCRIPTION OF THE DRAWINGS

The invention will be described with reference to the accompanying drawings, wherein like numbers reference like elements.

FIG. 1 is a perspective view illustrating the overall configuration of a printer according to a first embodiment.

FIG. 2 is a perspective view of a simplified configuration of a head unit.

FIG. 3 is a perspective view of a simplified configuration of a recording head included in the head unit.

FIG. 4 is a side view illustrating a simplified configuration of a maintenance device.

FIG. 5 is a side view illustrating a simplified configuration of a cam portion.

FIG. 6 is a plan view showing a simplified configuration of a flushing unit.

FIGS. 7A and 7B are schematic views illustrating an example of an absorbing member, FIG. 7A is a cross-sectional view, and FIG. 7B is a plan view.

FIG. 8 is a perspective view of a simplified configuration of a cap unit.

FIG. 9 is a diagram illustrating a state during a flushing operation.

FIG. 10 is a diagram illustrating a state during a recording operation.

FIG. 11 is a diagram illustrating a state during a capping operation.

FIG. 12 is a diagram illustrating a rack and pinion mechanism.

### DESCRIPTION OF EXEMPLARY EMBODIMENTS

Hereinafter, exemplary embodiments of the invention will be described with reference to the accompanying drawings. In the drawings used for the following description, in order to allow each member to have a recognizable size, the scale of each member is appropriately changed.

In this embodiment, as a fluid ejecting apparatus, an ink jet printer (hereinafter, simply referred to as a printer) is exemplified.

### First Embodiment

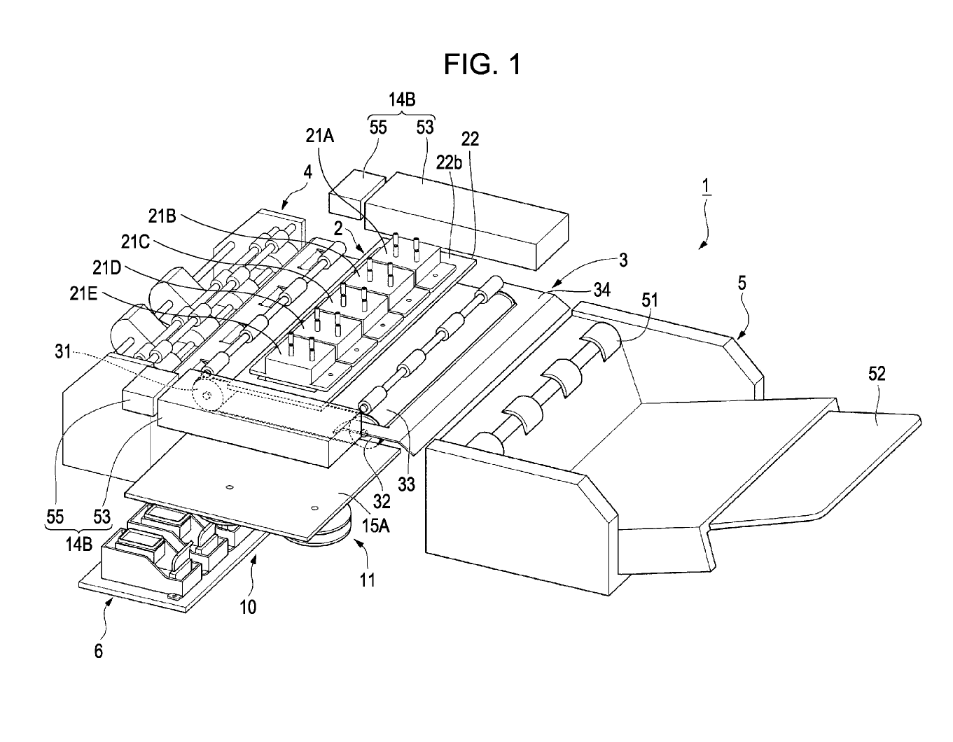

FIG. 1 illustrates a fluid ejecting apparatus according to an embodiment of the invention.

FIG. 1 is a perspective view illustrating a simplified configuration of a printer.

As illustrated in FIG. 1, the printer 1 includes a head unit 2, a transport device 3 that transports a recording sheet (recording medium), a sheet feed unit 4 that supplies the recording sheet, a sheet discharge unit 5 that discharges the recording sheet printed by the head unit 2, and a maintenance device 10 that performs a maintenance process on the head unit 2.

The transport device 3 is configured to hold a recording sheet while opening a predetermined interval from a nozzle formation surface 23 of each of the recording heads (fluid ejecting heads) 21 (21A, 21B, 21C, 21D, and 21E) included in the head unit 2. The transport device 3 includes a driving roller portion 31, a driven roller portion 32, and a transport belt portion 33 configured of a plurality of belts rotationally suspended on the roller portions 31 and 32. In addition, a holding member 34 that holds the recording sheet is provided on the downstream side (sheet discharge unit 5 side) of a transport direction of the recording sheet in the transport device 3 and between the transport device 3 and the sheet discharge unit 5.

The driving roller portion 31 has one end side in a rotation shaft direction, that is connected to a driving motor (not shown), and thus is driven by the driving motor to rotate. In addition, a rotating force of the driving roller portion 31 is transmitted to the transport belt portion 33 so as to rotate the transport belt portion 33. A transmission gear is installed between the driving roller portion 31 and the driving motor as needed. The driven roller portion 32 is a so-called free roller and is rotated according to the rotational driving of the transport belt portion 33 (the driving roller portion 31) while supporting the transport belt portion 33.

The sheet discharge unit 5 includes a sheet discharge roller 51 and a sheet discharge tray 52 that holds the recording sheet transported by the sheet discharge roller 51.

The head unit 2 is configured by unitizing a plurality of (in this embodiment, 5) recording heads 21A to 21E, and a plurality of colors of ink (for example, black B, magenta M, yellow Y, and cyan C ink) is discharged from nozzles 24 (see FIG. 3) of each of the recording heads 21A to 21E. The recording heads 21A to 21E (hereinafter, there may be cases where they are referred to as a recording head 21) are mounted on a mounting plate 22 to be unitized. That is, in the head unit 2 according to this embodiment, a line head module is configured by combining the plurality of recording heads 21 so that an effective printing width of the head unit 2 is substantially equal to the horizontal width of the recording sheet (a width perpendicular to the transport direction). Moreover, the recording heads 21A to 21E each have the common structure.

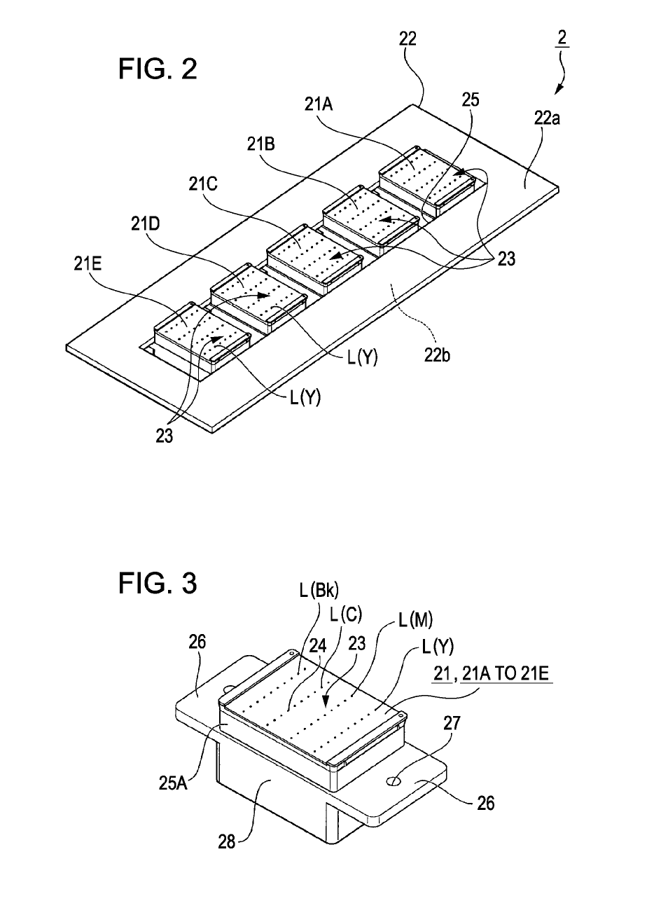

FIG. 2 is a perspective view of a simplified configuration of the head unit.

As illustrated in FIG. 2, in the head unit 2, the recording heads 21A to 21E are disposed in an opening portion 25 provided in the mounting plate 22. Specifically, each of the recording heads 21A to 21E is screwed to a rear surface 22b side of the mounting plate 22, and the nozzle formation surface 23 is disposed to protrude from a surface 22a side of the mounting plate 22 through the opening portion 25. In addition, the head unit 2 is mounted in the printer 1 as the mounting plate 22 is fixed to a carriage (not shown).

In this embodiment, in the head unit 2, maintenance processes (a suction process and a wiping process) are performed by the maintenance device 10 described later.

FIG. 3 is a perspective view of a simplified configuration of the recording head (fluid ejecting head) included in the head unit.

As illustrated in FIG. 3, each of the recording heads 21A to 21E (hereinafter, there may be a case where they are simply referred to as the recording head 21) included in the head unit 2 includes a head main body 25A having the nozzle formation surface 23 in which a plurality of nozzle rows L including a plurality of nozzles 24 is formed, and a supporting member 28 to which the head main body 25A is mounted.

Each of the recording heads 21A to 21E has nozzle rows L(Y), L(M), L(C), and L(Bk) corresponding to four colors yellow (Y), magenta (M), cyan (C), and black (Bk) and thus forms four nozzle rows L. In each of the nozzle rows L(Y), L(M), L(C), and L(Bk), the nozzles 24 included in the nozzle rows L(Y), L(M), L(C), and L(Bk) are arranged in the horizontal direction intersecting the transport direction of the recording sheet. Specifically, the nozzles 24 are arranged in the horizontal direction perpendicular to the transport direction of the recording sheet.

In addition, with regard to the nozzle rows, the recording heads 21A to 21E are disposed so that the nozzle rows L having the same color in the disposition direction of the recording heads 21A to 21E are arranged in a line. Moreover, in each of the recording heads 21A to 21E, with regard to the nozzle rows (L(Y), L(M), L(C), and L(Bk)), two rows for each color may be formed to make a total of eight rows. In this case, it is preferable that the two nozzle rows provided for each color be disposed in a zigzag pattern.

In the supporting member 28, extending portions 26 are provided on both sides of the nozzle formation surface 23 in the longitudinal direction, and the extending portions 26 are provided with through-holes 27 for screwing the recording head 21 to the rear surface 22b of the mounting plate 22. Accordingly, the plurality of recording heads 21 is mounted on the mounting plate 22 to assemble the head unit 2 (see FIG. 1).

The head unit 2 according to this embodiment is configured to be movable between a recording position, a flushing position, and a capping position. Here, the recording position is a position at which the entire head unit 2 is opposed to a recording sheet and recording is performed on the corresponding recording sheet, the flushing position is a position at which a flushing process is performed on the head unit 2, and the capping position is a position at which the nozzle formation surface 23 of each recording head 21 in the head unit 2 is sealed.

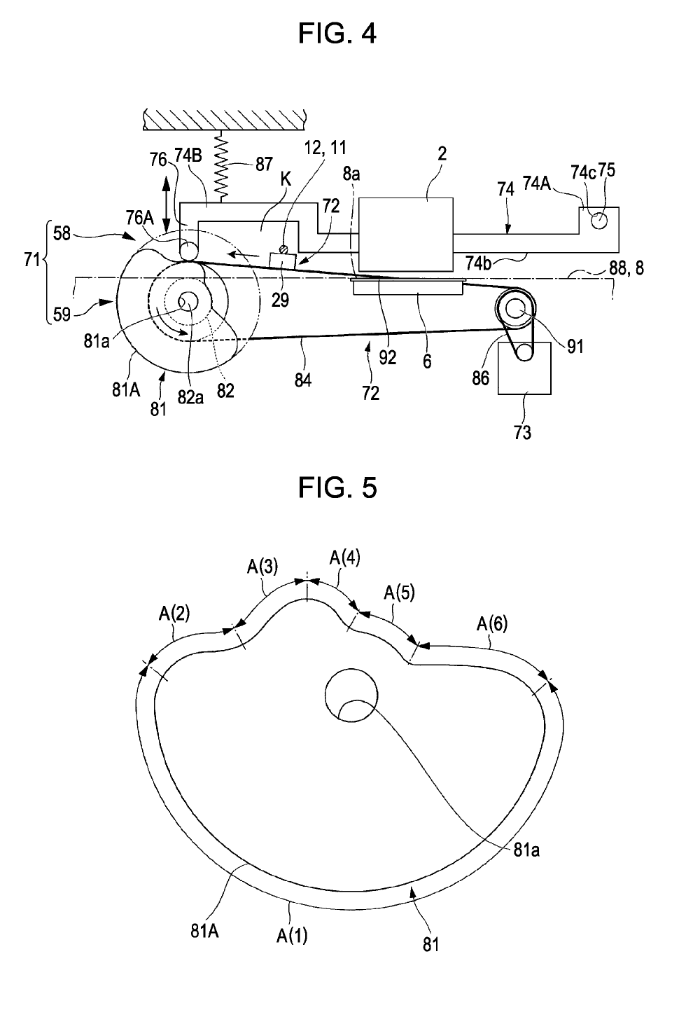

FIG. 4 is a side view illustrating a simplified configuration of the maintenance device. FIG. 5 is a side view illustrating a simplified configuration of a cam portion.

As illustrated in FIG. 4, the maintenance device 10 according to this embodiment includes a head moving mechanism 71 that moves the head unit 2, a flushing unit 11 provided with an absorbing member 12 for receiving ink discharged from each head in a flushing operation, an absorbing member moving mechanism 72 that moves the absorbing member 12 in the flushing unit 11, and a cap unit 6 that performs a suction process on the head unit 2.

In this embodiment, the head moving mechanism 71 and the absorbing member moving mechanism 72 have the same driving motor 73.

Here, in a printer, when a recording process is performed on a recording sheet (recording medium), the recording sheet needs to be supported by a platen 8 so as to be in a predetermined posture (parallel) with respect to the recording head 21. In this embodiment, the surface of the platen 8 functions as a transport surface 88 of the recording sheet and is represented by the dot-dashed line in FIG. 4.

The head moving mechanism 71 has an oscillation mechanism 58 and a cam mechanism 59.

The oscillation mechanism 58 includes a holding member 74 that holds the head unit 2, a support shaft 75 (turning support member) that pivotally supports one end portion 74A of the holding member 74 so as to be turnable, and a contact portion 76 provided in the other end portion 74B of the holding member 74.

The holding member 74 has a plane shape so as to be able to hold the head unit 2 described above and specifically, has a size corresponding to the mounting plate 22 (see FIG. 2) to which the plurality of recording heads 21 is mounted. The head unit 2 is mounted in the holding member 74 substantially at the center of the transport direction of the recording sheet so that the nozzle formation surface 23 (FIG. 2) of each recording head 21 protrudes toward the transport surface 88 from the rear surface 74b of the holding member 74.

Moreover, the holding member 74 may have a configuration with the function of the mounting plate 22, or the plurality of recording heads 21 may be directly fixed to the holding member 74.

The support shaft 75 is inserted into an insertion hole 74c formed in the one end portion 74A of the holding member 74, and the holding member 74 is positioned by the support shaft 75 so that a predetermined interval is provided between the rear surface 74b on the end portion 74A side and the transport surface 88. In addition, the support shaft 75 is loosely fitted to the insertion hole 74c so that the other end portion 74B side can be oscillated about the end portion 74A side as the fulcrum.

In addition, the end portion 74B side from the head unit 2 of the holding member 74 is bent toward the opposite side to the transport surface 88 to form a space K between the end portion 74B and the transport surface 88. In addition, the contact portion 76 extending toward the transport surface 88 from the end portion 74B comes into contact with the cam portion 81 described later so as to be supported by the cam portion 81. Specifically, a rotation roller 76A mounted on a tip of the contact portion 76 so as to be rotatable comes into contact with the cam portion 81.

The cam mechanism 59 includes a pair of cam portions 81, a camshaft 82 that connects the cam portions 81 to each other, a timing belt 84 rotationally suspended on the camshaft 82 and a shaft 91, and the driving motor 73.

The pair of cam portions 81 has a substantially semicircular shape in a side view, and each is opposed so that their side surfaces are opposed to each other on both sides of the width direction (a direction intersecting the transport direction) of the platen 8. The cam portions 81 forming a pair opposed in an aligned posture so that their shapes overlap in the plan view, and are simultaneously rotated in the same direction about a shaft portion 82a of the camshaft 82 fitted into shaft holes 81a (the hole 81a of one cam portion 81 is not shown). Specifically, the pair of cam portions 81 is disposed at a position that is under the holding member 74 and is opposed to the end portion 74B of the holding member 74, and the rotation roller 76A of the holding member 74 abuts on the side peripheral surface thereof.

As illustrated in FIG. 5, the side peripheral surface 81A of each cam portion 81 has a plurality of continuous cam areas A, and the cam areas A have different distances from the shaft hole 81a. In this embodiment, for example, six cam areas include a first cam area A(1) that forms a concentric arc with the shaft portion, a second cam area A(2) that draws a predetermined curve from the first cam area A(1) and extends toward the shaft portion, a third cam area A(3) that draws a predetermined curve from the second cam area A(2) to extend and forms a concentric arc with the shaft portion, a fourth cam area A(4) that draws a predetermined curve from the third cam area A(3) and further extends toward the shaft portion, a fifth cam area A(5) that draws a predetermined curve from the fourth cam area A(4) to extend and forms a concentric arc with the shaft portion, and a sixth cam area A(6) that draws a predetermined curve from the fifth cam area A(5) and extends toward the first cam area A(1).

Moreover, the number of cam areas A is not limited and is appropriately set depending on the distance of each cam area A from the shaft hole 81a and the like.

The cam portions 81 in this embodiment are disposed so that the hole 81a (the shaft portion 82a of the camshaft 82) is positioned on the side lower than the transport surface 88, in other words, on the opposite side to the head unit 2 with respect to the transport surface 88.

The belt 84 is rotationally suspended on the camshaft 82 and the shaft 91 disposed at an interval from the camshaft 82 in the transport direction.

The shaft 91 is connected to the driving motor 73 via the timing belt 84 provided on one end side of the axial direction and is driven to rotate at a predetermined rotation speed by the driving motor 73. In addition, the rotating force of the shaft 91 is transmitted to the timing belt 84, such that the timing belt 84 is driven to rotate. The timing belt 84 is rotated clockwise (forward rotation) or counterclockwise (reverse rotation) by the operation of the driving motor 73.

The above-described camshaft 82 is a so-called driven roller and is rotated according to the rotational driving of the belt 84 (shaft 91) while supporting the timing belt 84. A transmission gear may be installed between the shaft 91 and the driving motor 73 as needed.

In addition, as the rotation roller 76A of the holding member 74 which abuts on the side peripheral surface 81A in response to the rotation (forward rotation and reverse rotation) of each of the cam portions 81 continuously comes into contact with the plurality of cam areas A lined up in the peripheral direction, the holding member 74 is oscillated, and accordingly, the position of the head unit 2 with respect to the transport surface 88 is changed in the vertical direction.

In the head moving mechanism 71 according to this embodiment, a pressing member 87 that presses the holding member 74 against the cam portions 81 is provided. The pressing member 87 is a coil-shaped spring member, and has one end side mounted on the end portion 74B of the holding member 74 and the other end side mounted on another member (fixed member) of the printer.

The absorbing member moving mechanism 72 moves the flushing unit 11 (the absorbing member 12) disposed between the transport surface 88 (platen 8) of the recording sheet, the holding member 74, and the head unit 2 to the flushing position and a standby position depending on the transport direction of the recording sheet, and includes the timing belt 84, a connection portion 29 that connects the timing belt 84 to the flushing unit 11, and the driving motor 73.

Here, the flushing position is a position at which the head unit 2 and the flushing unit 11 are opposed to each other. That is, the flushing position is a position at which the absorbing member 12 below the head unit 2 is opposed to the nozzle rows (the plurality of nozzles 24 that constitutes the nozzle rows L) of the corresponding recording head 21 and thus accommodates and absorbs ink droplets discharged from the nozzle rows L during the flushing operation, that is, a position on a flying path of ink.

On the other hand, since a retraction position is a position at which the absorbing member 12 is more on the upstream side than the head unit 2 and thus is not opposed to the head unit 2 (is not overlapped therewith in the plan view), ink droplets discharged from each nozzle 24 (FIG. 2) for recording during a recording operation are not absorbed by the absorbing member 12. Specifically, the absorbing member 12 is disposed inside the space K formed between the holding member 74 and the transport surface 88 (the cam portion 81).

The flushing unit 11 (the absorbing member 12) is able to reciprocate along the transport direction by the rotation (forward rotation and reverse rotation) of the timing belt 84 connected to the driving motor 73. Control of a movement speed and a stop position of the flushing unit 11 (the absorbing member 12) can be arbitrarily adjusted by a rotation angle of the driving motor 73. Accordingly, even when the recording head 21 having the plurality of nozzle rows L in the transport direction is provided, the stop position of the absorbing member 12 can be set to a position opposed to each nozzle row L, and a scanning speed can be appropriately set.

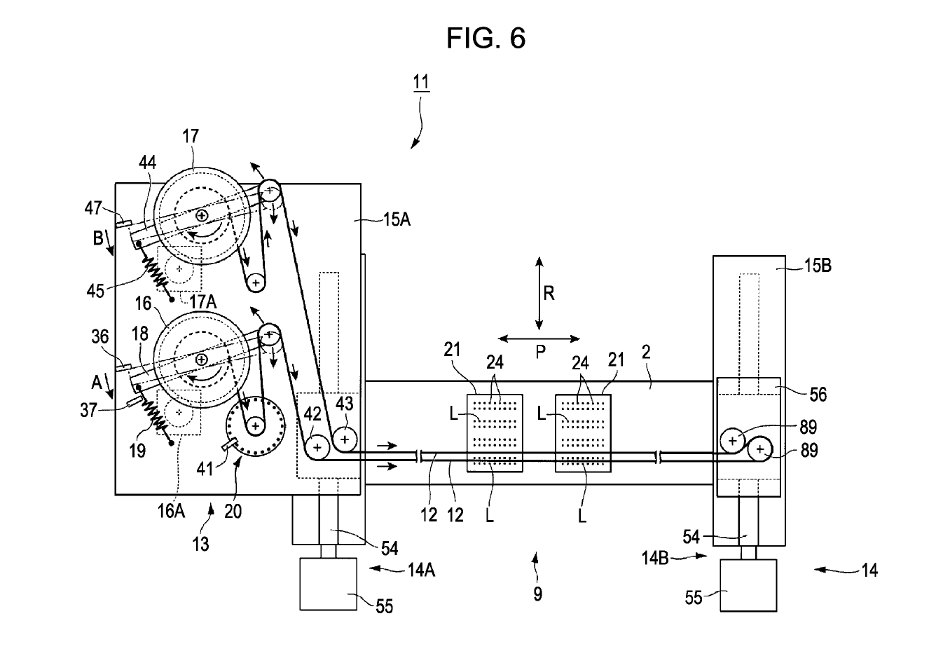

The flushing unit 11 includes a plurality of the absorbing members 12 and a support mechanism 9 (see FIG. 6) that supports the plurality of the absorbing members 12. Moreover, in FIG. 4, for the sake of simplification, only the absorbing member 12 is shown. In addition, although the single absorbing member 12 is shown, actually, the plurality of (in this embodiment, 4) absorbing members 12 for the respective colors is provided.

FIG. 6 is a plan view illustrating an example of the flushing unit 11.

As illustrated in FIG. 6, the flushing unit 11 includes the plurality of absorbing members 12, and the support mechanism 9 that supports the plurality of absorbing members 12.

The support mechanism 9 includes a traveling unit 13 that causes the absorbing member 12 to travel in one direction, and a moving unit 14 that moves the absorbing member 12 a predetermined distance. In this embodiment, the support mechanism 9 is provided in one direction of the arrangement direction of the plurality of recording head 21 of the head unit 2.

Moreover, in FIG. 6, a portion of the head unit 2 is omitted, and only two recording heads 21 are shown. In addition, in the recording heads 21 that are included in the head unit 2, two nozzle rows L for each of the colors (Y), (M), (C), and (Bk) are formed to make a total of 8 rows.

The travelling unit 13 includes support substrates 15A and 15B disposed on both sides of the head unit 2, and reverse rollers 89 provided on the support substrate 15B, and causes the absorbing member 12 to travel from the one side to the other side along the nozzle rows L of the recording head 21 and then causes the absorbing member 12 to travel to the one side again by turning the reverse rollers 89.

On the support substrate 15A, a sending reel 16, a sending motor 16A, an adjusting lever 18, a tension spring 19, a first sensor 36, a second sensor 37, an inspection rotating body 20, a detecting unit 41, a roller 42, a winding reel 17, a winding motor 17A, a safety lever 44, a tension spring 45, a safety sensor unit 47, and a roller 43 are provided.

The roller 42 and the roller 43 are disposed so that the positions of the absorbing member 12 that runs over the rollers 42 and 43, that is, points of the absorbing member 12 in a direction R perpendicular to the extension direction P have an interval that is the same as a pitch between the adjacent nozzle rows L from among the plurality of (in this embodiment, 8) nozzle rows L formed in the recording head 21. The positions of the absorbing member 12 opposed to the head unit 2 are determined by the rollers 42 and 43.

The travelling unit 13 causes the absorbing member 12 wound out from (sent from) the sending reel 16 to run over the roller 42, pass through the side opposed to the head unit 2, and reach the one reverse roller 89, so as to cause the absorbing member 12 in the forward path to extend along the nozzle row L. In addition, the travelling unit 13 causes the absorbing member 12 to run over the one reverse roller 89, pass the other reverse roller 89, pass through the side opposed to the head unit 2 again, and reach the roller 43, so as to cause the absorbing member 12 in the return path to extend along the nozzle L.

In addition, the absorbing member 12 that runs over the roller 43 passes the plurality of rollers to be wound round the winding reel 17.

The moving unit 14 is constituted by a pair of moving mechanism units 14A and 14B provided in the support substrates 15A and 15B, and as the moving mechanism units 14A and 14B are operated in synchronization with each other, the support substrates 15A and 15B are moved to the same side in the direction R, at the same time, by the same distance. In the moving mechanism units 14A and 14B, ball screws 54 are rotated as motors 55 are rotated, and a fixed block 56 screwed to the ball screw 54 is moved in the length direction of the ball screws 54, that is, in the R direction of FIG. 6. Accordingly, the support substrates 15A and 15B fixed to the moving mechanism units 14A and 14B are moved to the same side in the direction R, at the same time, by the same distance as described above. In addition, along the movement of the support substrates 15A and 15B, the absorbing member 12 is moved in the same manner. Moreover, the motor 55 is rotatable in the forward and reverse directions, so that the fixed block 56, the support substrates 15A and 15B, and the absorbing member 12 are movable to both sides in the R direction.

In addition, the motor 55 is controlled by a controller (not shown), so that the moving unit 14 is moved so as to change the position of each absorbing member 12 with respect to the head unit 2 (the nozzle row L) as set in advance. Specifically, the absorbing member 12 is moved by a distance set in advance in the direction R perpendicular to the extension direction P of the nozzle row L corresponding to the head unit 2, that is, in the transport direction of the recording sheet.

Moreover, the support mechanism 9 that supports the absorbing member 12 according to this embodiment is only an example, and the invention is not limited thereto. The motor 55 may also have the function of the driving motor 73.

The absorbing member 12 has a line shape that absorbs ink droplets discharged from each nozzle 24, and in this embodiment, two absorbing members 12 are provided for a single head unit 2. Each of the absorbing members 12 is disposed in the extending state along the corresponding nozzle rows L(Y), L(M), L(C), and L(Bk) and is disposed between each nozzle formation surface 23 and a transport area of the recording sheet.

The absorbing member 12 is formed of, for example, a yarn material or the like, and those that can effectively absorb and hold (accommodate) ink are appropriately used. Specifically, the absorbing member 12 may be formed of fiber such as SUS304, nylon, nylon with hydrophilic coatings, aramid, silk, cotton, polyester, ultra-high-molecular-weight polyethylene, polyarylate, Xyron (brand name), or the like, or a composite fiber including a plurality of kinds thereof.

More specifically, fiber bundles formed of the fiber or the composite fiber are twisted or tied to form the absorbing member 12.

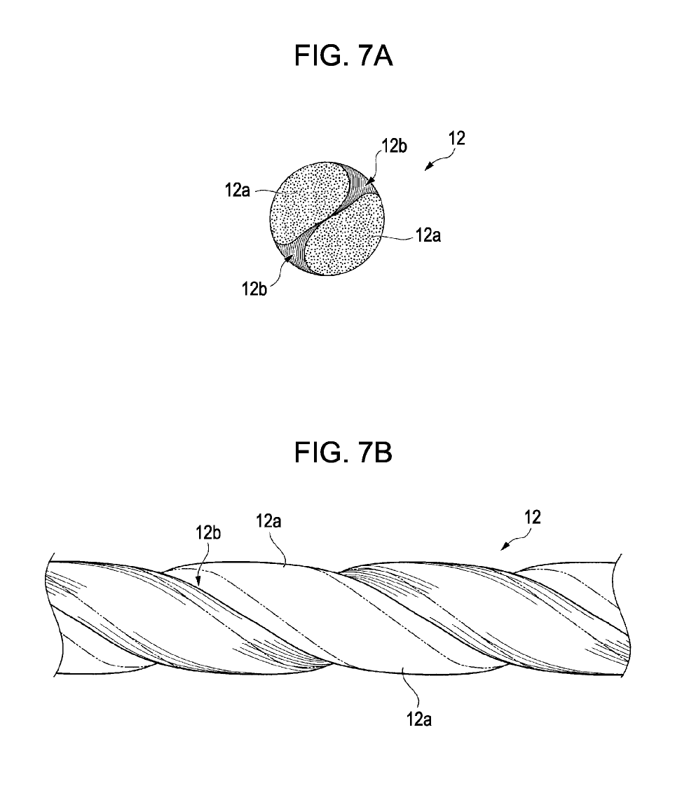

FIGS. 7A and 7B are schematic views illustrating an example of the absorbing member 12, FIG. 7A is a cross-sectional view, and FIG. 7B is a plan view. As shown in the figures, the absorbing member 12 is formed by, for example, twisting two fiber bundles 12a formed of fiber.

In addition, as another example, a line-shaped member made by twisting a plurality of fiber bundles formed of SUS304, a line-shaped member made by twisting a plurality of fiber bundles formed of nylon, a line-shaped member made by twisting a plurality of fiber bundles formed of nylon with hydrophilic coatings, a line-shaped member made by twisting a plurality of fiber bundles formed of aramid, a line-shaped member made by twisting a plurality of fiber bundles formed of silk, a line-shaped member made by twisting a plurality of fiber bundles formed of cotton, a line-shaped member made by twisting a plurality of fiber bundles formed of Belima (brand name), a line-shaped member made by twisting a plurality of fiber bundles formed of Soarion (brand name), a line-shaped member made by twisting a plurality of fiber bundles formed of Hamilon 03T (brand name), a line-shaped member made by twisting a plurality of fiber bundles formed of Dyneema Hamilon DB-8 (brand name), a line-shaped member made by twisting a plurality of fiber bundles formed of Vectran Hamilon VB-30, a line-shaped member made by twisting a plurality of fiber bundles formed of Hamilon S-5 Core Cable Sleeve Polyester (brand name), a line-shaped member made by twisting a plurality of fiber bundles formed of Hamilon S-212 Core Cable Sleeve Polyester (brand name), a line-shaped member made by twisting a plurality of fiber bundles formed of Hamilon SZ-10 Core Zylon Sleeve Polyester (brand name), or a line-shaped member made by twisting a plurality of fiber bundles formed of Hamilon VB-3 Vectran (brand name) may be appropriately used as the absorbing member 12.

The absorbing member 12 using the fiber formed of nylon is formed of nylon which is widely used as general-purpose yarn and is thus cheap.

The absorbing member 12 using metallic fiber such as the SUS material has excellent corrosion resistance and thus is able to absorb various kinds of ink, and has high wear resistance compared to resin and thus is able to be repeatedly used.

The absorbing member 12 using the fiber formed of ultra-high-molecular-weight polyethylene has high breaking strength and chemical resistance, and is resistant to organic solvents, acids, and alkalis. As such, due to the high breaking strength, the absorbing member 12 using the fiber formed of ultra-high-molecular-weight polyethylene can be pulled at a high tension, thereby suppressing deflection. Accordingly, for example, printing precision can be enhanced by thickening the diameter of the absorbing member 12 and increasing absorption capacity, or by reducing the distance from the heads 21A to 21E to the transport area of the recording sheet in a case where the diameter of the absorbing member 12 is not thickened. In addition, the absorbing member 12 using the fiber formed of Xyron or aramid is expected to have the same effect as the absorbing member 12 using the fiber formed of ultra-high-molecular-weight polyethylene.

The absorbing member 12 using the fiber formed of cotton has excellent ink absorptiveness.

In the absorbing member 12, dropped ink is held in a valley portion 12b (see FIGS. 7A and 7B) formed between the fiber and between the fiber bundles 12a by surface tension, so that the ink is absorbed and accommodated.

In addition, a portion of the ink dropped on the surface of the absorbing member 12 directly penetrates into the absorbing member 12, and the remainder flows down the valley portion 12b formed between the fiber bundles 12a. In addition, a portion of the ink penetrating into the absorbing member 12 moves gradually in the extension direction of the absorbing member 12 inside the absorbing member 12 and is dispersed in the extension direction of the absorbing member 12 to be held. A portion of the ink flowing down the valley portion 12b of the absorbing member 12 gradually penetrates into the absorbing member 12 while flowing down the valley portion 12b, and the remainder remains in the valley portion 12b, so that the ink is dispersed in the extension direction of the absorbing member 12 to be held. That is, not all of the ink dropped on the surface of the absorbing member 12 stays in the drop points in the long term and the ink is dispersed in the vicinity of the drop points to be absorbed.

Moreover, a material actually forming the absorbing member 12 installed in the printer 1 is appropriately selected in consideration of ink absorbency, an ink holding property, tensile strength, ink resistance, formability (an amount of fluff or unraveling generated), torsibility, cost, and the like.

In addition, an amount of ink absorbed by the absorbing member 12 is the sum of an amount of ink that can be held between the fiber of the absorbing member 12 and an amount of ink that can be held by the valley portion 12b. Accordingly, the material to form the absorbing member 12 is selected in consideration of an exchange frequency of the absorbing member 12 and the like so that the amount of ink absorbed is sufficiently greater than an amount of ink discharged by the flushing.

Moreover, the amount of ink that can be held between the fiber of the absorbing member 12 and the amount of ink that can be held by the valley portion 12b can be specified by a contact angle between the ink and the fiber, and a capillary force at a fiber clearance that depends on the surface tension of the ink. That is, by forming the absorbing member 12 using fine fiber, the clearance between the fibers is increased, so that the total surface area of the fiber is increased. Accordingly, even though the cross-sectional area of the absorbing member 12 is the same, the absorbing member 12 can absorb a larger amount of ink. Therefore, in order to increase the clearance between the fibers, as the fiber to form the fiber bundle 12a, microfiber (ultrafine fiber) may be used.

Here, as the clearance between the fibers is increased and the capillary force is reduced, the ink holding force of the absorbing member 12 is reduced. Accordingly, the clearance between the fiber needs to be set so that the ink holding force of the absorbing member 12 has a level so as not to cause the ink to drop due to the movement of the absorbing member 12.

In addition, the thickness of the absorbing member 12 is set to, for example, a thickness (diameter) of 5 to 75 times the diameter (nozzle diameter) of the nozzle 24. In a general printer, a gap between each nozzle formation surface 23 and the recording sheet in each of the recording heads 21A to 21E is about 1 mm to 2 mm, and the nozzle diameter is about 0.02 mm. Therefore, when the diameter of the absorbing member 12 is equal to or smaller than 0.5 mm, the absorbing member 12 can be disposed between each nozzle formation surface 23 and the recording sheet without coming into contact therewith, and when the diameter thereof is equal to or greater than 0.2 mm, the absorbing member 12 can reliably catch the discharged ink droplets even in consideration of error in the components. Therefore, it is preferable that the thickness (diameter) of the absorbing member 12 be about 0.2 mm to 0.5 mm, that is, about 10 to 25 times the nozzle diameter. Moreover, the cross-sectional shape of the absorbing member 12 is not necessarily circular and may be polygonal or the like. Here, since it is difficult to form the absorbing member to be completely circular, a substantially circular shape is included.

In addition, it is preferable that the length of the absorbing member 12 be a sufficient length with respect to an effective printing width of the head unit 2. The printer 1 according to this embodiment employs, as described later, a configuration in which a used (ink absorbed) area of the absorbing member 12 is sequentially wound, and when almost all areas of the absorbing member 12 absorb ink, the entire absorbing member 12 is replaced. Accordingly, so as to cause a replacement period of the absorbing member 12 to be a practically withstandable time, it is preferable that the length of the absorbing member 12 be several hundreds of times the effective printing width of the head unit 2. The absorbing member 12 having this configuration is supported by the support mechanism 9 as illustrated in FIG. 6.

As illustrated in FIG. 4, the cap unit 6 performs the maintenance process on the head unit 2 and is disposed in an area lower than the transport surface.

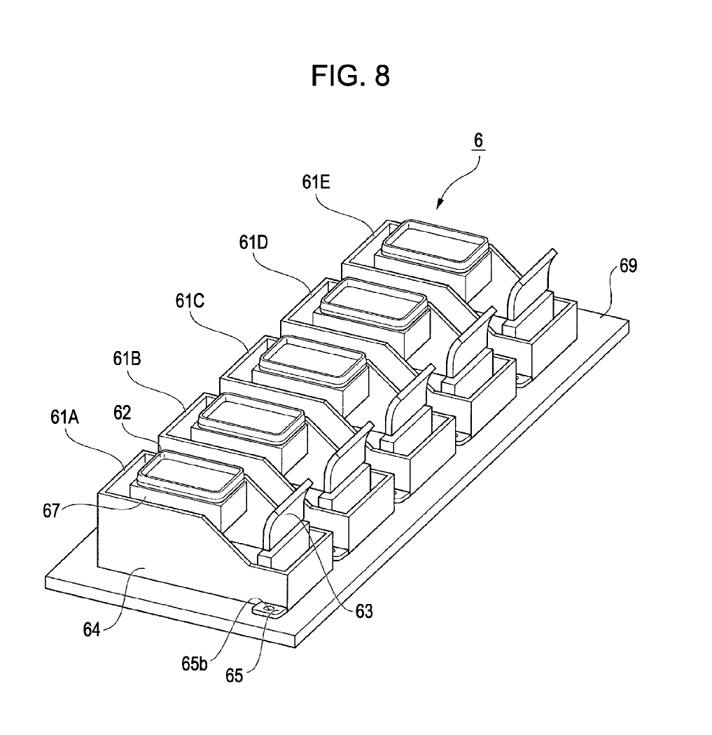

FIG. 8 is a perspective view of a simplified configuration of the cap unit.

As illustrated in FIG. 8, the cap unit 6 is configured by unitizing a plurality of (in this embodiment, 5) cap portions 61A to 61E corresponding to the respective recording heads 21A to 21E. The cap unit 6 is disposed at a place out of a recording area of the head unit 2.

The cap portions 61A to 61E (hereinafter, there may be a case where they are simply referred to as a cap portion 61) are provided to correspond to the respective recording heads 21A to 21E so as to abut on the nozzle formation surfaces 23 of the respective recording heads 21A to 21E. In this configuration, the cap portions 61A to 61E come in close contact with the nozzle formation surfaces 23 of the respective recording heads 21A to 21E and thus can properly perform a suction operation of discharging ink (fluid) from the nozzles 24 of the respective nozzle formation surfaces 23.

In addition, each of the cap portions 61A to 61E includes a cap main body 67, a seal member 62 that is provided on the top surface of the cap main body 67 in a frame shape to abut on the recording head 21, a wiping member 63 used for a wiping process of wiping the nozzle formation surface 23 of the recording head 21, and a housing portion 64 that integrally holds the cap main body 67 and the wiping member 63.

At a lower portion of the housing portion 64, two holding portions 65 (one is not shown) to hold the housing portion 64 on a base member 69 are formed. The holding portions 65 are disposed at positions forming opposing corners in the housing portion 64 in the plan view. Each of the holding portions 65 is provided with a through-hole 65b through which a screw for screwing and fixing the housing portion 64 to the base member 69 is inserted.

In this configuration, the flushing unit 11 is connected to the timing belt 84 with the connection portion 29 and reciprocates in the transport direction along the movement of the timing belt 84. Since the timing belt 84 is rotationally suspended on the shafts 82 and 91 that have different diameters from each other, a portion of the timing belt 84 obliquely extends from the shaft 91 side to the camshaft 82 side having a greater diameter than that of the shaft 91. Accordingly, for example, in the case where the flushing unit 11 (the absorbing member 12) is disposed at the flushing position, if the timing belt 84 turns in the counterclockwise direction, the flushing unit 11 moves obliquely upward with respect to the transport surface 88 and is disposed at the standby position. The distance between the flushing unit 11, that is, the absorbing member 12 and the transport surface 88 at the standby position is greater than that at the flushing position, so that the contact between the absorbing member 12 disposed at the standby position and the recording sheet can be avoided during recording.

In this embodiment, as illustrated in FIG. 4, a shutter member 92 (cover member) that is able to cover the cap unit 6 is provided. The shutter member 92 has a flat plate shape and is provided under the platen 8 to slide to follow the lower surface, and is thus operated to open and close a head insertion hole 8a provided in the platen 8. The shutter member 92 has the flat plate shape, and it is preferable that the size thereof in the plan view be greater than that of the head insertion hole 8a. Moreover, it is natural that the shutter member 92 has a size to simultaneously cover the plurality of cap portions 61 of the cap unit 6. In addition, the shutter member 92 is reciprocated along the transport direction of the recording sheet by a moving mechanism (not shown). Here, a configuration in which the shutter member 92 is moved to the upstream side (the cam portion 81 side) of the transport direction of the recording sheet more than the head insertion hole 8a is employed. However, a configuration in which the shutter member 92 is moved to the downstream side that is the opposite side to that may also be employed.

In addition, with regard to the configuration of the platen 8, the platen 8 may be made of a single plate member, or a configuration in which a pair of plate members is disposed at a predetermined interval in the transport direction so as to insert the head unit 2 therebetween may also be employed.

Next, with regard to the operations of the printer, operations of the flushing unit are mainly described.

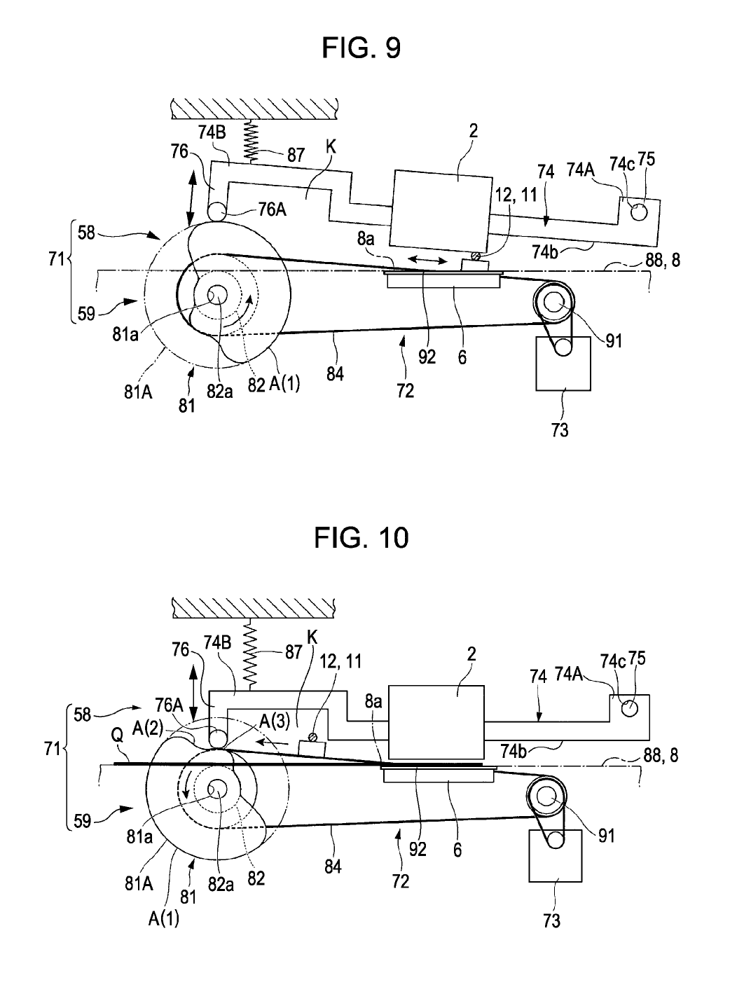

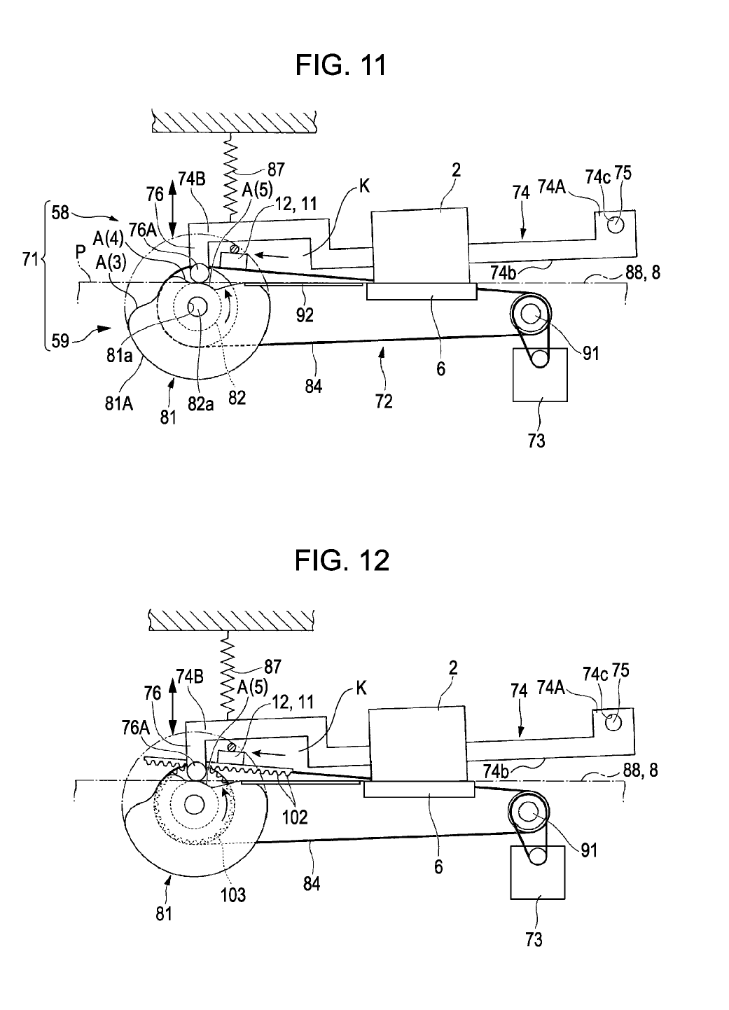

FIG. 9 is a diagram illustrating a state during the flushing operation, FIG. 10 is a diagram illustrating a state during the recording operation, and FIG. 11 is a diagram illustrating a state during a capping operation.

As illustrated in FIG. 9, with regard to the state during the flushing operation, the rotation roller 76A of the holding member 74 abuts on the first cam area A(1) of the cam portion 81, and the head unit 2 and the flushing unit 11 are disposed at the flushing position. Each of the absorbing members 12 provided in the flushing unit 11 is disposed at the position opposed to the nozzle row L of the corresponding recording head 21 of the head unit 2 and accommodates ink discharged from the recording head 21.

During the flushing operation, the cam portion 81 is rotated counterclockwise at a predetermined speed (constant speed) by the operation of the driving motor 73. When the rotation roller 76A of the holding member 74 rotates while abutting on the first cam area A(1), the state in which the head unit 2 is disposed at the flushing position is maintained.

The holding member 74 has a configuration in which the end portion 74B side is oscillated about the support shaft 75 of the end portion 74A side, and the head unit 2 is fixed to the holding member 74. Therefore, in the state where the rotation roller 76A abuts on the first cam area A(1) of the cam portion 81 and thus the end portion 74B side is higher than the end portion 74A side (the state where the absorbing member 12 is disposed at the flushing position), the nozzle formation surface 23 (FIG. 2) of each of the recording heads 21 of the head unit 2 is inclined with respect to the transport surface 88.

Moreover, this posture is a posture that does not affect the flushing process, and ink droplets protruding from each nozzle row L are reliably accommodated by the opposed absorbing member 12 disposed immediately therebelow, so that a problem in which ink wets the nozzle formation surface 23 and spreads or the like does not occur.

In addition, during the flushing operation, the head insertion hole 8a of the platen 8 is blocked by the shutter member 92. As the cap unit 6 is covered by the shutter member 92, it is possible to prevent ink droplets ejected by the flushing process from adhering to and contaminating the cap portion 61A and the vicinity thereof.

The pressing member 87 contracts to the maximum state at the flushing position at which the end portion 74B of the holding member 74 is raised to the maximum state. However, there is no change in the front end side of the holding member 74 being urged toward the cam portion 81 by the pressing member 87, and the abutting state of the rotation roller 76A on the side peripheral surface 81A (cam area) is properly maintained.

In addition, during the flushing operation, that is, while the rotation roller 76A abuts the first cam area A(1) of the cam portion 81, the flushing process may be performed on the nozzle rows L sequentially while rotating the timing belt 84 at a predetermined rotation speed. However, the flushing process may also be performed by temporarily stopping the turning of the timing belt 84 at the position at which the absorbing member 12 is opposed to the target nozzle row L.

Here, the flushing process may also be performed after the position of each absorbing member 12 with respect to the head unit 2 (the nozzle row L) is adjusted by the moving unit 14 of the flushing unit 11 described above. As such, by the turning of the timing belt 84 and the operation of the moving unit 14 of the flushing unit 11, the absorbing member 12 is reliably disposed immediately below the target nozzle row L, and the flushing process is performed on the entire nozzle rows L corresponding to each color of the recording head 21.

Moreover, if it is possible to reliably dispose the absorbing member 12 immediately below the nozzle row L which becomes a process target only by turning the timing belt 84, the moving unit 14 described above may be omitted.

As illustrated in FIG. 10, while the rotation roller 76A abuts on the second cam area A(2), the flushing unit 11 is moved to the upstream side (the cam portion 81 side) of the transport direction of the recording sheet as the timing belt 84 is turned and is disposed at a first standby position. The first standby position is set to a position in the space K formed between the holding member 74 and the transport surface 88, and at the position, the flushing unit 11 does not abut on the holding member 74 that is oscillated and lowered as the rotation roller 76A abuts on the second cam area A(2).

After the flushing operation is terminated, the recording operation is performed.

As illustrated in FIG. 10, when the rotation roller 76A of the holding member 74 that abuts on the first cam area A(1) passes the second cam area A(2) and abuts on the third cam area A(3) as the cam portion 81 is rotated, the head unit 2 is disposed at the recording position. The head unit 2 disposed at the recording position discharges ink toward the recording sheet transported on the transport surface 88 (platen 8) and performs recording. Here, the head insertion hole 8a of the platen 8 is blocked by the shutter member 92 disposed on the rear surface side. As the head insertion hole 8a is covered by the shutter member 92, concave portions of the cam portions 61A to 61E in the cap unit 6 do not have an influence on the transportation of the recording sheet Q during recording.

The head unit 2 disposed at the recording position is in a posture in which each nozzle formation surface 23 is parallel with the transport surface 88.

When there is a period until a subsequent recording operation is performed after the recording operation is ended, the capping operation is performed.

As illustrated in FIG. 11, when the rotation roller 76A of the holding member 74 which abuts on the third cam area A(3) as the cam portion 81 newly rotates, passes the fourth cam area A(4) and abuts on the fifth cam area A(5), the head unit 2 is disposed at the capping position.

During a period in which the rotation roller 76A abuts on the fourth cam area A(4), as the timing belt 84 turns, the flushing unit 11 is moved to a second standby position on the side further upstream than the first standby position. The second standby position is a position set between the holding member 74 and the sixth cam area A(6) of the cam portion 81, and at the second standby position, the distance between the absorbing member 12 and the transport surface 88 becomes greater than that at the first standby position.

In addition, in synchronization with the movement of the flushing unit 11, the shutter member 92 is moved to the upstream side in the transport direction by a moving mechanism (not shown). Accordingly, when the rotation roller 76A abuts on the fifth cam area A(5), a portion of the head unit 2 is inserted into the head insertion hole 8a.

The head unit 2 disposed at the capping position is pressed against the cap unit 6 in a state where the nozzle formation surface 23 of each recording head 21 protrudes downward from the transport surface 88. This capping state is held during the period in which the rotation roller 76A abuts on the fifth cam area A(5).

As such, as the holding member 74 is oscillated and the head unit 2 is moved to the cap unit 6 side with the rotation of the cam portion 81, when the recording head 21 is caused to come in close contact with the cap portion 61, the flushing unit 11 (the absorbing member 12) is already disposed at the standby position. Accordingly, even though the entire recording head 21 is moved to the platen 8 side and blocks a transport line of the recording sheet Q, there is no problem. As the head unit 2 in which the nozzle formation surface 23 is horizontal at the recording position is moved to the cap unit 6 side, the nozzle formation surface 23 is inclined with respect to the transport surface 88 in the reverse direction to that during flushing. According to the posture of the head unit 2, each cap portion 61 is fixed to the cap unit 6 while being inclined.

Moreover, the cap unit 6 is disposed more under the transport surface 88 and is disposed at a position so as not to protrude upward (on the holding member 74 side) from the transport surface 88 from the head insertion hole 8a.

In addition, when the capping operation is ended, the cam portion 81 (the timing belt 84) is reversed by the operation of the driving motor 73 to perform the recording operation or the flushing operation. Accordingly, the rotation roller 76A of the holding member 74 does not abut on the sixth cam area A(6).

In this embodiment, the absorbing member moving mechanism 72 and the head moving mechanism 71 are configured to include the same driving motor 73, such that the absorbing member moving mechanism 72 is in synchronization with the operation of the head moving mechanism 71 by the operation of the driving motor 73. That is, the upward and downward movement (the oscillation of the holding member 74) of the head unit 2 and the reciprocation scanning movement (the reciprocating movement of the flushing unit 11) of the absorbing member 12 are synchronized with each other, so that a time needed for the flushing process can be reduced. Accordingly, a time needed for the maintenance is reduced, so that it becomes possible to quickly transit the flushing process to the recording operation or the capping operation.

In addition, by the timing belt 84 rotationally suspended on the camshaft 82 and the shaft 91 having different diameters from each other, the flushing unit 11 (the absorbing member 12) is moved to the upstream side of the transport direction while being raised obliquely with respect to the transport surface 88 and thus becomes distant from the head unit 2 and increases a distance from the transport surface 88. Therefore, it becomes possible to avoid the contact between the absorbing member 12 and the transport surface 88.

Moreover, it becomes possible to set the interval between the absorbing member 12 and the nozzle 24 during the flushing process to an interval at which ink droplets discharged from each recording head 21 are reliably accommodated by the absorbing member 12 without leaking.

In addition, the absorbing member 12 itself is reciprocated linearly along the transport direction and thus the amplitude of the absorbing member 12 can be suppressed to the minimum, so that the absorbing member 12 can quickly start the flushing process after the movement.

During the recording operation, since the distance between the recording sheet Q and the nozzle formation surface 23 is small, there is a concern of the absorbing member 12 coming into contact with the two. However, it is possible to cause the absorbing member 12 to wait at a position distant from the nozzle formation surface 23 and the transport surface 88 at the first standby position, so that the contact of the absorbing member 12 with the nozzle formation surface 23 and the transport surface 88 can be avoided. In this embodiment, the configuration in which the distance between the absorbing member 12 and the nozzle formation surface 23 is ensured by disposing the flushing unit 11 at the first standby position is employed. However, since even the distance between the nozzle formation surface 23 and the absorbing member 12 can be set to an arbitrary distance, there is no limitation to the diameter of the absorbing member 12, and an arbitrary thickness of the absorbing member 12 can be employed. Accordingly, an accommodation range of ink is widened, and a stop position of the absorbing member 12 can be set without good precision, thereby achieving controllability and a cost reduction. In addition, it becomes possible to suppress the amplitude of the absorbing member 12 while the stopped state is continuous by thickening the diameter of the absorbing member 12.

In addition, in this embodiment, the head unit 2 is moved in the vertical direction by rotating the cam portion 81. Therefore, precision in positioning the head unit 2 with respect to the transport surface 88 is enhanced, and a load applied during the vertical operation of the head unit 2 can be reduced, which is advantageous in terms of durability.

Moreover, according to the configuration in this embodiment, the vertical movement of the head unit 2 and the horizontal movement of the flushing unit 11 (the absorbing member 12) are operated by the driving source in a single system, so that with simple control and without a change in synchronization of the operations, the movement of the two can be made with good precision. In addition, the movement of the two can be realized by a relatively simple configuration, so that the manufacturing cost is cheap.

In addition, the configuration of the flushing unit 11 is not limited to the above configuration, and for example, a configuration in which the sending reel 16 and the winding reel 17 are disposed on both sides of the head unit 2 in the direction intersecting the transport direction and the rotations of the two are synchronized with each other to scan the absorbing member 12 from the one side to the other side of the nozzle row L may be employed.

In addition, the moving unit 14, the adjusting lever 18, the tension spring 19, the inspection rotating body 20, the sensors 36 and 37, the detecting unit 41, the safety sensor unit 47, and the like are not necessarily needed as long as the absorbing member 12 can be scanned without deflection. Moreover, the absorbing member 12 sent from the sending reel 16 is wound round the winding reel 17 by passing the plurality of rollers. However, the number of rollers passed is not limited to the above number and may be suitably set.

While the exemplary embodiments related to the invention have been described with reference to the accompanying drawings, it is needless to say that the invention is not limited to the related examples. It can be understood by those skilled in the art that various alterations and modifications can be apparently made without departing from the spirit and scope of the embodiments of the invention, and those naturally belong to the spirit and scope of the invention.

In addition, according to the invention, the absorbing member moving mechanism 72 and the head moving mechanism 71 are not limited to the configurations of the embodiments and may employ other configurations.

For example, in the above embodiments, the pair of cam portions 81 is disposed on both sides of the platen 8 in the width direction (in the direction intersecting the transport direction). However, a configuration in which only a single cam portion 81 is disposed on any side may also be employed. In this case, the holding member 74 is oscillated by the rotation of the single cam portion 81 and thus the head unit 2 is moved in the vertical direction.

In addition, instead of the absorbing member moving mechanism 72, a configuration using a rack and pinion and the like may also be employed (for example, FIG. 12).

A rack and pinion mechanism 101 as illustrated in FIG. 12 includes a rack 102 connected to the flushing unit 11 and a pinion gear 103 that is engaged with the rack 102 and is rotated by the driving motor. The pinion gear 103 is provided integrally with the camshaft 82 and rotates in synchronization with the cam portion 81 to move the rack 102, thereby moving the absorbing member 12 between the first standby position, the second standby position, and the flushing position. Even in this configuration, the same effects as those of the embodiment can be obtained.

While the exemplary embodiments related to the invention have been described with reference to the drawings, the invention is not limited to the related examples, and various modifications can be made without departing from the spirit and scope of the invention.

In addition, in the above embodiments, the configuration in which the absorbing member 12 is parallel with the nozzle row is described. However, according to the invention, the extension direction of the absorbing member 12 does not necessarily need to be completely parallel with the extension direction of the nozzle row. That is, according to the invention, extending along the nozzle row is not limited to the state of being completely parallel with the nozzle row and may be in a range in which the absorbing member 12 receives the ink droplets (fluid) during flushing.

In addition, in this embodiment, the configuration in which the invention is applied to the line head-type printer is described. However, the invention is not limited to this and may also be applied to a serial-type printer.

In addition, in this embodiment, the configuration in which the absorbing member 12 is always moved between the head and the recording sheet (medium) is described. However, the invention may employ a configuration in which when the absorbing member 12 is retracted, the absorbing member 12 is moved to an area deviating from immediately below the head (for example, a side of the head).

In the above embodiment, the fluid ejecting apparatus according to the invention is applied to the ink jet printer. However, any fluid ejecting apparatus for ejecting or discharging fluids different from ink may be employed. That is, the fluid ejecting apparatus can be applied to various types of fluid ejecting apparatuses having fluid ejecting heads or the like for discharging minute liquid droplets. Moreover, the liquid droplets represent fluid states discharged from the fluid ejecting apparatus, the liquid states including granular, tear-like, and thread-like shapes with trails. In addition, fluid mentioned herein may be any material that can be ejected by the liquid ejecting apparatus.

For example, the materials may be in a liquid phase, and may include liquid-state materials with high or low viscosities, sol, gel water, fluid-state materials such as inorganic solvent, organic solvents, solutions, liquid resin, and liquid metal (metallic melt), and in addition to fluids as a state of materials, a material in which particles of functional materials made of solid such as pigment or metallic particles are dissolved, dispersed, or mixed with the solvent. In addition, as a representative example of the fluid, there is the ink described above in the embodiment. Here, the ink may include various kinds of fluid compositions such as general water-based ink, oil-based ink, gel ink, hot-melt ink, and the like.

Particular examples of the fluid ejecting apparatus may include liquid crystal displays, EL (electroluminescence) displays, surface light-emitting displays, fluid ejecting apparatuses for ejecting fluid in which materials such as electrode materials used for manufacturing color filters and color materials are dispersed or dissolved, fluid ejecting apparatuses for ejecting biological organic materials used for manufacturing biochips, fluid ejecting apparatuses which are used as precision pipettes and used for ejecting fluid as specimens, printing apparatuses, and microdispensers.

Moreover, fluid ejecting apparatuses for ejecting lubricating oil to precision machinery such as watches or cameras with pinpoint precision, fluid ejecting apparatuses for ejecting transparent resin fluid such as ultraviolet curable resin on substrates to form micro-hemispherical lenses (optical lenses) or the like used for optical communication elements or the like, and fluid ejecting apparatuses for ejecting acidic or alkaline etchant for etching substrates or the like may be employed.

What is claimed is:

1. A fluid ejecting apparatus comprising:
a nozzle row including a plurality of nozzles arranged in a direction intersecting a transport direction of a recording medium transported on a transport surface;
a fluid ejecting head that ejects fluid from the nozzle row;
an absorbing member that extends along the nozzle row and absorbs fluid ejected from the nozzles;
a head moving mechanism that moves the fluid ejecting head between a flushing position at which the fluid ejecting head and the absorbing member are opposed to each other and a standby position at which the fluid ejecting head and the absorbing member are not opposed; and
an absorbing member moving mechanism that is linked to the head moving mechanism and moves the absorbing member between the flushing position and the standby position.

2. The fluid ejecting apparatus according to claim 1, wherein the absorbing member moving mechanism and the head moving mechanism are configured to have the same driving motor.

3. The fluid ejecting apparatus according to claim 1, wherein the absorbing member moving mechanism moves the absorbing member obliquely with respect to the transport direction so that an interval between the absorbing member and the transport surface at the retraction position is greater than that at the flushing position.

4. The fluid ejecting apparatus according to claim 1, wherein the head moving mechanism includes:
a holding member that holds the fluid ejecting head;
a turning support member that supports one end side of the holding member to be turnable; and
a cam portion that oscillates the holding member by supporting and rotating the other end side of the holding member to cause the fluid ejecting head to reciprocate between the standby position and the flushing position.

5. The fluid ejecting apparatus according to claim 4, wherein a side peripheral surface of the cam portion is provided with a first area to dispose the fluid ejecting head at the flushing position and a second area to dispose the fluid ejecting head at the standby position.

6. The fluid ejecting apparatus according to claim 4, further comprising a cap member that is disposed at a position opposed to a nozzle formation surface of the fluid ejecting head via the transport surface to seal the nozzle formation surface,
wherein the side peripheral surface of the cam portion is provided with a third area to dispose the fluid ejecting head at a position to cause the nozzle formation surface to be sealed by the cap member.

7. The fluid ejecting apparatus according to claim 4, wherein the head moving mechanism is provided with a pressing member that presses the holding member against the cam portion side.
